(19) United States
(12) Patent Application Publication
(10) Pub. No.: US 2007/0101281 A1
(43) Pub. Date: May 3, 2007

(54) Method and system for an electronic pictorial communication mechanism

(76) Inventors: Nate Simpson, Groveport, OH (US); Erik Paul Bethke, Laguna Woods, CA (US); Raymond F. Ratcliff III, Austin, TX (US)

Correspondence Address: DENIS KHOO, 9729 CAMINO REAL, ARCADIA, CA, 91007, US

(21) Appl. No.: 11/263,225

(22) Filed: Oct. 31, 2005

(51) Int. Cl. G06F 3/00; G06F 17/20; G06F 17/21

(52) U.S. Cl. 715/764; 704/1; 704/10

(57) ABSTRACT

A method and system is described for a pictorial communication tool. The method comprises searching for pictures that may have multiple language definitions, placement of the pictures in a Cartesian plane, determining a destination for the message, and then sending the message. A system is further disclosed and claimed for enabling the above methodology over a data network.

### BACKGROUND OF THE INVENTION

1. Field of the Invention

The present invention relates generally to electronic communication over a data network, and more particularly to, a method and system for enabling users to use pictures and icons within a software mechanism that enables electronic communication.

2. Description of the Related Art

Communication in an online world continues to mature and evolve, both increasing the ease with which people can communicate and increasing the total number of people that can participate in online communication.

Historically, the vast majority of online communication has been via email. A second popular form of communication online has been Instant Messaging (IM). Both of these forms of communication have become popular and gained mass acceptance because of their ease of use for communication among people who speak the same language.

The existing dominant communication systems have several disadvantages.

The primary disadvantage of existing communication systems concerns language and localization. This flaw is based on the precept that two parties that wish to communicate online require some common language.

A secondary disadvantage has to do with asynchronous vs. synchronous communication methods. Email is currently the dominant form of asynchronous communication while IM is the dominant form of synchronous communication. Because each of these methods is text-based, neither enables people to communicate other languages in a live (synchronous) or time-delayed (asynchronous) manner.

A need therefore exists for a system that enables language-agnostic communication that works in both synchronous and asynchronous manners.

### SUMMARY OF THE INVENTION

The present invention provides for a method for multiple users to communicate online using an agnostic pictorial language.

Rather than using western or eastern-based alphabets as building blocks for words and sentences, the pictorial language described herein uses pictures and icons to enable participants to communicate ideas, themes, queries, and answers.

For the sake of simplicity, the word “picture” will be used throughout this description. However, “picture” or “pictorial” could be replaced for all practical purposes with “icon” or “iconic”.

Traditional alphabet-based languages have tremendous flexibility in the types of words, and subsequent meanings, that can be created. These structures are quite valuable for people that communicate using that language, but the very nature of that complexity makes learning other languages a difficult endeavor. Not only is there a steep learning curve for every language and alphabet system around the world, but words themselves can have ambiguous meanings that result in issues with definition, translation, misunderstandings, and accessibility for people with cognitive disabilities.

Although a myriad of automatic translation-based services exist, their application is rarely satisfactory. These systems often translate words in a literal translation, and very rarely can properly deduce the true meaning intended by the author. There are too many special rules for every language in terms of grammar and context that feed into the actual meaning of the sentence. Automatic language translators do not yet have the artificial intelligence sophistication to know all of these rules and how to properly apply them between languages.

Pictures offer an alternative to alphabet-based systems for communication. Pictures are already used in many international physical venues for communicating common themes such as where to find baggage in airports, where to find a phone on the street, or where to find the exit in a subway.

Pictorial and symbolic communication was the only way of communication in much of the world prior to the creation of complex phonics-based alphabets. Ancient Egyptians used hieroglyphics and Native American populations used similar pictorial representations for communication. These ancient systems often were not cross-cultural, as the Aztec symbols for “king” and “death” were different than the Egyptian symbols for “king” and “death.”

In today's media-savvy world, there has become a universal iconography that spans international borders. Television, books, magazines, and movies have taken certain universal themes and created a common understanding of visual representations of not only objects, but also verbs, emotions, thoughts, and other more subjective subjects. For example, a “heart” picture between a man and woman picture is generally understood to mean “love”. This symbol would have been generally unrecognizable to most cultures 1,000 years ago.

A simple example of how pictures can be used to communicate across language barriers would be a sentence such as “I broke my arm.” Using pictures, the author could use 1) a picture of himself coupled with 2) a picture of an arm and 3) and object breaking. These pictures could be linked together to communicate, “I broke my arm”, and it would be understandable in every language, since these pictures represent symbols with which all cultures and languages share familiarity.

In order for a picture-based communication tool to be useful for authors and readers, there must be a number of features available. These features include but are not limited to, a system that allows the attachment of multiple text definitions in one or several languages to a single picture, a system that allows the addition of new pictures, a searching mechanism that enables users to find a particular picture, and a system for culling and filtering pictures based on the frequency with which they are used by speakers of a given language. Each of these will be described in detail.

The first of the features mentioned above is a known-language definition for every picture. This essentially means that every picture in the system must have at least one word associated with it. For example, a picture of a car must have the word “car” associated with it. When the picture of the car is sent to the other person, they can see the picture and the word definition if they so wish. Most commonly, this definition can be viewed by using a “mouseover” action, when the on-screen cursor hovers over the picture, the proper translation will appear. This definition tool must apply to “known-language”. That is, if the English-speaking author sends a picture of a “car” to someone in Japan that does not speak English, the local word definition should be in Japanese. Thus, each party must have their local authoring and reading tool set to their local language so that readers can see the proper definition of the picture for their respective language.

The second feature is one that enables the creation and insertion of new pictures into the system. The system features a central dictionary to which multiple users add new icons and definitions. Without the ability to update the central dictionary, a pictorial-based tool is limited by the number of pictures in its lexicon. Authors need to have a robust number and variety of pictures in order to communicate their thoughts and ideas via icons. There will be situations when the existing inventory of pictures is not satisfactory for the author, so the author must have the ability to add a picture. A second situation is one in which the author can find a picture that communicates his ideas, but the picture is not entirely satisfactory. In these situations, the author must be able to add an additional picture to the lexicon that better communicates his symbolic representation of the idea that he wishes to communicate.

For example, the author may wish to send a message to his friend that has the word “espresso”, but there is currently no picture in the system. There are several pictures for coffee, but it does not quite meet the needs of the author. The author can create his own picture of “espresso” and insert it into the system so that it may be included in his message.

A third important feature for this international picture-based communication tool is the ability for users to search for particular pictures within the system. This feature works together with the feature above that enables authors to create new pictures when the search results are unsatisfactory. This system presupposes that pictures may have one or more words associated with them to make the searching mechanism more robust. Additionally, search results can be expanded to results including associated words, alternate forms of words, homonyms, and synonyms. Because pictures can sometimes not represent single words, but also phrases, concepts, or ideas, there is not always a one-to-one relationship between pictures and definitions. Therefore, certain word searches will result in pictures that represent phrases or other multiple word combinations.

Users can instigate the picture search process in a variety of manners. Using a “picture location” tool, the user may enter a search word or phrase in their preferred language. The user may input this picture search criteria either with a keyboard or using voice recognition technology.

A fourth feature is the search results ranking system. In order for a pictorial language to satisfy the largest number of authors and readers, there must be some semblance of commonality and uniformity in the language. The best way to do this is by using a “natural use” technique where a service is constantly watching patterns of picture-use and then using these results to influence future picture choices. This is the same system that is used in the creation of alphabet-based languages as well. For example, in the beginning of the English language, there were many different ways to say what is now commonly known as “shirt”. People would say “kurta”, “middy”, “shirt”, “dashiki”, and other words. Over time, the word “shirt” became the most popular, so it is now the word of choice to symbolize a garment for the upper body. The feature in the pictorial tool needs operates in the same way and enable users to automatically “vote” on the best pictures to represent words, ideas, or concepts. As users enter words to search for in the tool, they are presented with a series of results. If no pictures exist for the word, then no results are returned. If one picture exists, then one picture is returned. If multiple pictures exist, then the pictures are presented in order of popularity. Each subsequent selection counts as another vote in the popularity ranking. In another embodiment of the above ranking system, the user may wish to customize how ranking is done. For example, they may wish to sort the results by author name, by which is most popular among his group of friends, or by the predominance of the color green within each image.

When the author constructs the message, it can be transmitted to one or more people either synchronously or asynchronously.

In a synchronous environment, users can use an IM-type client for communication. The IM client can accept traditional text or pictures. The communication tool may be a multiple window application that includes an area for typing, an area for communication, and an area for picture searching. The search results can be dragged into the communication window for real-time transmission of pictures.

Asynchronously, the author may construct a pictorial message and then send it to one or more users. The message will then remain in the destination “mailbox” until the user retrieves the message. In this sense, the message is transmitted just like email, except the data within the message is a series of pictures rather than letters.

The pictorial messages themselves can be very diverse and made to illustrate movement or action between symbols. Pictures can be “combined” with other symbols to add extra communication indicators to further clarify the ideas or concepts being communicated in the pictorial sequence. These symbols can include traditional Boolean operators such as joins (and), unjoins (or), exclusives (xor), negatives (not), and equality (equal). Each of these can be communicated by a set of symbols could exist outside of the picture language itself. For example, the pictures themselves are listed inside cells. The cells themselves can be joined together by the user to indicate an “and”. A cell containing a picture can have a red slash drawn across it to indicate a “not”. A cell can have an arrow pointing to a cell beside it to indicate that one picture is acting on another picture. This “meta-level” system can thus be used to create a level of meaning to the pictures themselves to add additional contextual data about how the pictures should be “read” to communicate certain ideas or concepts.

Cells inside pictorial messages can also have circular references and other innovative ways to show relationships between pictures. For example, there may be a single picture of “love” which is referenced several times throughout the pictorial message via a series of connections that attach to the cell that contains the picture for “love”.

The “pictures” themselves can be more than simple pictures. These images may include 2D animations, animated 3D objects, or recorded or live video of any duration. They may also be associated with or solely composed of sound files of any duration.

Another aspect of the pictorial based language described herein is the order in which the pictures are displayed. In one embodiment of this invention, the pictures are displayed in a grid of picture “holders.”These pictures may be placed in any order, and in any relative orientation, the author desires. This loose structure enables both authors and readers to be creative in the display of messages. This structure enables those cultures that are comfortable reading from top left to bottom right comfortable as well as vice-versa. This open Cartesian plane provides an open canvas for users to create their own structure.

In another embodiment, the pictures can be arranged in a consecutive linear order. Users may wish to place the pictures in sequential order, where one picture is placed after the next in a left to right fashion. The series of pictures would approximate a corresponding written sentence. For example, the user may show a series of three pictures, ordered from left to right, the pictures showing a cat followed by a heart followed by a pizza. The corresponding sentence would be “cat likes pizza”.

In another embodiment of this invention is the creation of a pictorial language on a three-dimensional plane, where the picture “cells” may be located in different positions on the x, y, and z planes.

Pictures may also be “overlayed” with other pictures. By combining pictures via overlapping, it is possible to create new meanings of the pictures themselves. Some of the overlaying pictures may also be used to communicate the picture's meaning and relevance to other nearby pictures. For example, the user may place a picture of a heart inside of a cell and overlay it with another picture that points to the right, indicating that they love the object in the cell to the right, rather than loving another object in another direction.

With this invention, it is possible for computers to generate pictorial messages. Given that artificial intelligence (AI) systems can already communicate with humans with alphabetic languages, another option may be communication via pictorial languages. There are many circumstances when a computer may need to initiate a pictorial message automatically to a user or a group of users. This can be used in the case of system messages, news, or other alerts.

Users are able to define groups of recipients for the messages. By creating a group list, the user can quickly access a large group of people to contact at the same time. Group lists are a convenient way for a single user to communicate their pictorial message to several other people at the same time.

Also with this invention, a business can communicate with all of its customers via a pictorial message. The business may have many international customers that do not speak a common language. Rather than writing n number of messages in each language, the same task could be accomplished via a pictorial language, which can be seen and understood by all recipient parties, regardless of the language they speak.

This invention can also be applied in a gaming environment where the prominent form of communication could be a pictorial symbolic language. There are three possible interaction groupings within a gaming environment that can be useful: players communicating with other players, players communicating with non-player characters (NPCs), and NPCS talking to other NPCs. An NPC is a computer-controlled player. In the first case, players can communicate with other players in a private manner, where only the participants can see the pictorial communication, or public manner, where everyone in the game could potentially see the pictorial communication. For example, Player A may walk up to Player B and say, “your dress is pretty” or “I have fruit in my pants”. In the second case, the player can talk to an NPC to accomplish some sort of task or desire. For example, Player A may walk up to an NPC shopkeeper and say, “I want a blue sword” or “I am looking for the lake”. In the third case, two NPCs may be having a public or semi-private conversation in plain view of the other players. The purpose will be so that the players can glean some sort of information by watching the two NPCs communicate. For example, one NPC may approach another NPC and say, “There are now green apples on sale,” or “I like pizza”.

The NPCs above are shown in the form of on-screen avatars in a gaming environment. Avatars, in this context, are defined as virtual characters that interact with the user and with other virtual characters. Avatars can take many forms, such as pets, humans, flowers, dragons, etc. Users may choose to use avatars as a medium for communicating pictorial messages to other users or other users' avatars.

The messages themselves can also accomplish more than simple communication. The messages can be used as transport mechanisms for other sorts of items including, but not constrained to money, virtual money, documents, executables, applications, games, web links, external pictures, music, video, and the like.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a technical block diagram view of the preferred embodiment of the present invention;

FIG. 2 is a flow chart of the preferred embodiment of the method of the present invention;

FIG. 3 is a diagram of a sample pictorial message;

FIG. 4 is a user interface of a tool for searching and ranking pictures;

FIG. 5 is a flow chart of an embodiment of the language definition system for pictorial messages;

FIG. 6 is a block diagram view of a general purpose computer that may be used to implement an embodiment of the method and system of the present invention.

### DETAILED DESCRIPTION OF THE PREFERRED EMBODIMENTS

System Overview

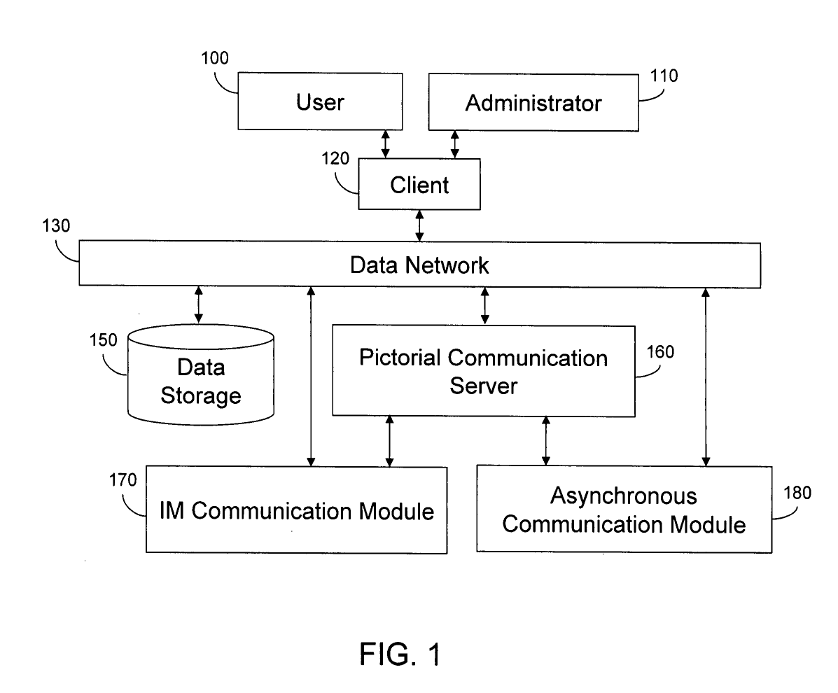

FIG. 1 is a technical block diagram view of the preferred embodiment of the computer system of the present invention.

FIG. 1 illustrates the various systems involved in the communication of a pictorial message between a client system 100 and the pictorial communication server 160.

The user 100 can read a pictorial message or create a pictorial message by interfacing with the client system 120. When creating a pictorial message, the user 100 will indicate the desired destination or destinations of the message. The pictorial message can be directed to either another user or the administrator 110 of the system. In either case, the pictorial message is relayed over a data network 130 to go from the sender to the recipient. The message can be delivered synchronously by utilizing the IM (Instant Messaging) Communication Module 170 or asynchronously by utilizing the Asynchronous Communication Module 180, as defined by the user 100, or automatically by the server 160 based on the online status of the recipients or any other criteria. If the user 100 desires to deliver the pictorial message to another user that is currently online, the message can be delivered synchronously via an IM Communication Module 150. If the user 100 desires, the message can also be delivered in an asynchronous manner and the message will be stored in the server storage medium 150 awaiting the retrieval of the intended recipient. It is also possible for all pictorial messages, whether sent synchronously or asynchronously, to be stored in the server storage medium 150.

Administrators 110 may also wish to send pictorial messages to a user 100 or group of users. Furthermore, it is possible that the server 160 itself may create pictorial messages and send them to users automatically on behalf of the administrator 110.

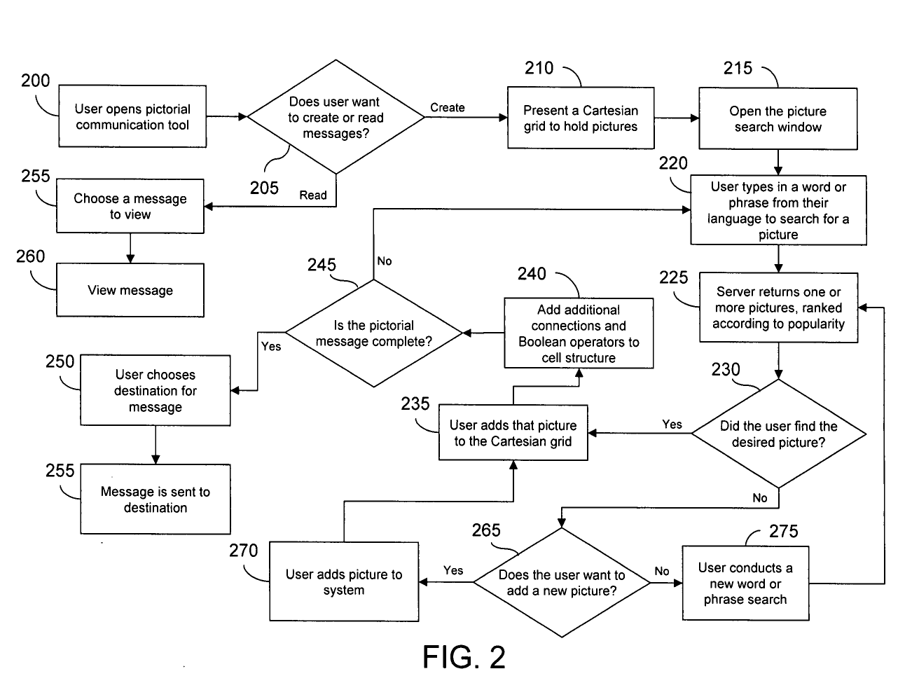

FIG. 2 shows a typical path a user may follow to practice the method of the described art. In step 200, the user 100 begins by opening a tool. This tool allows the user to create, send, and read pictorial messages. In step 205, the user chooses whether to create or read a message. In step 205, if the user chooses to read a message, the user will choose the message to view in step 255. After selecting the message, the user views the message in step 260.

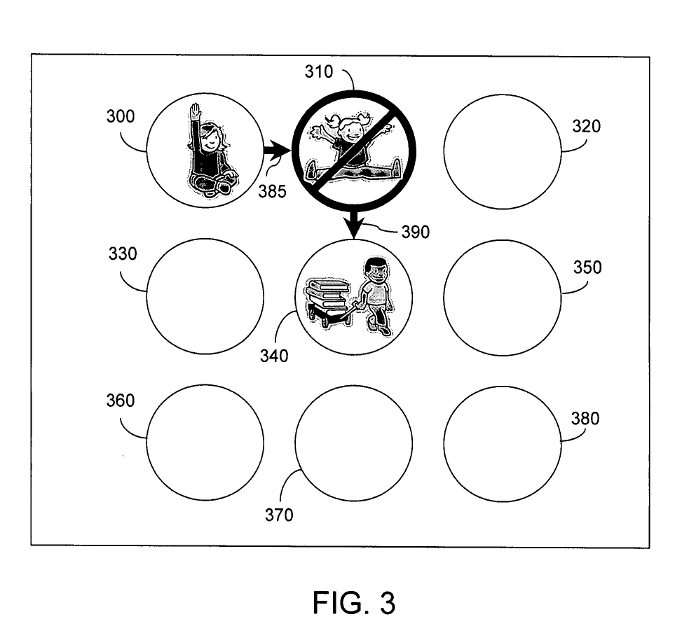

If the user wishes to create a message, the user is taken to step 210, where the user is presented with a palette to create a pictorial message on a Cartesian plane. There is greater detail about this palette in FIG. 3. Next, the user is provided with many options to create his/her pictorial message including reusing old messages, using templates or other pre-formed patterns, or, in this embodiment, by using a secondary window used for picture searching, as seen in step 215. The user types in a word from their preferred language to search for a picture, in step 220, and then the user is presented with a series of pictures, in step 225, that are ranked according to popularity. After this picture or series of pictures are returned, the user will determine if the resultant list contains a satisfactory picture for their message, in step 230. If the result set is not satisfactory, the user has a further option to add a new picture, in step 265, to the repository of pictures. If the user decides to add a new picture, the user will do so in step 270. If the user does not want to add a new picture in step 265, the user can then conduct a new word search, in step 275, to see another set of results in step 225.

In either case, whether the user likes the pictures returned, in step 230, or a new picture has been added to the database, in step 270, the chosen picture can be placed on the Cartesian message plane, as seen in step 235. The user can orient these pictures however they wish on that plane. Additionally, in step 240, the user can add connections between the pictures that might help further describe the relationship between the pictures to better communicate their message. A connection can be a Boolean operator or any other symbol which defines a relationship between two or more pictures. Some examples of connections include a line, arrow, math symbols, emoticons, punctuation symbols, and scientific symbols.

The user then can continue to add to their pictorial message if it is determined that the pictorial message is not complete in step 245. If the user chooses to add more pictures, they begin again at step 220 and continue this cycle until they have all the pictures they need and all the Boolean operators they need to communicate their message.

If the message is complete, the user can then choose a destination for the message in step 250. Note that this step can be completed anywhere in the above process and is not necessarily required at the end, as in this embodiment. Finally, the message is sent to the destination address in step 255.

FIG. 3 illustrates one of many embodiments of a pictorial message. This particular plane is a series of circles placed in an x/y grid. Various pictures can be placed in these circles to communicate a message. In this particular example, cell 300, 310, and 340 have been filled with pictures. The picture in cell 300 is a hominine with a hand in the air. In this case the “definition” of the picture is “I”, since the hominine is indicating itself. There may be a wide variety of pictures to represent “I”, but the user has chosen this one in particular.

In cell 310, the user has inserted a picture that shows a hominine in an excited jumping position. The literal definition of this picture is “enjoy”. The cell 310 itself is red with a line through the middle, indicating that the picture that resides therein is not true. Cell 310 is an example of a booloan operator that can be interpreted along with the pictures it represents. In this case, the interpretation is “Not Enjoy”, “Hate”, or “Dislike”. It is left up to the reader the exact meaning, although the literal definition is “Not Enjoy”.

The final cell 340 has been filled with a picture of a hominine pulling an apparatus containing books. The literal definition of this picture is “reading”. Taken all together, this pictorial message says “I do not enjoy reading” or “I hate reading”.

Between the cells are arrow connectors 385 and 390, which indicate there is a relationship between the pictures. In this example, “I” leads to “Not Enjoy” through connector 385, which then leads to “Reading” via connector 390.

When creating or reading a pictorial message, the user may also see definitions of the pictures. The definitions can be seen in another window or in pop-up text during a mouseover event. This mouseover event is sometimes called a “tooltip”. A tooltip is a small window that pops up over on top of the selected text and it provides additional textual information.

Similarly, the user may choose to translate the pictorial message via a toggle button. The toggle button enables users to switch back and forth between the picture view and the definition view, so that the user may correctly interpret the meanings behind the pictures.

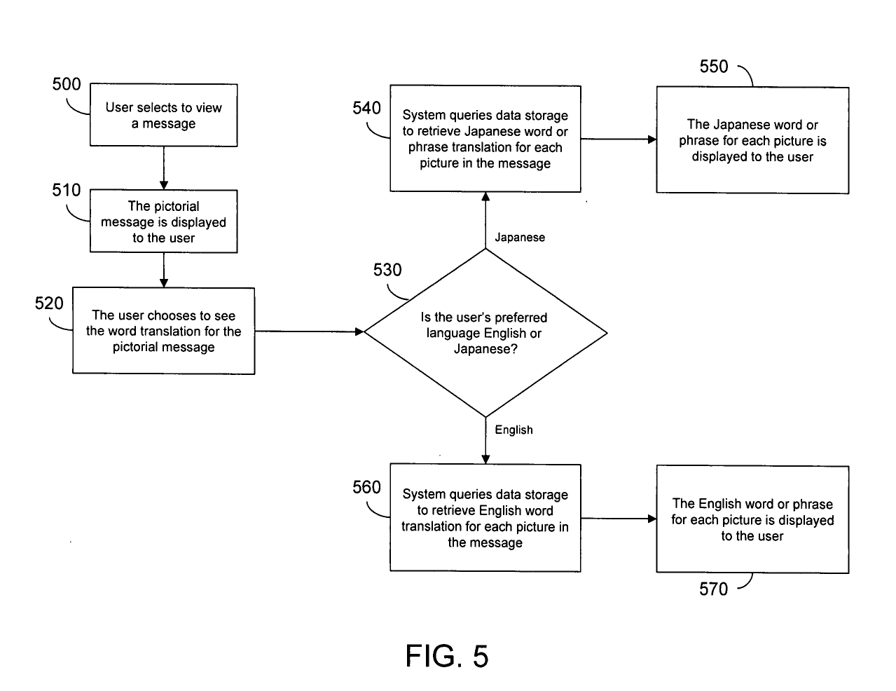

The message in FIG. 3 can be sent to recipients that speak any language. Upon looking at the definition for each of the pictures, they will see the definition in the language of their choice. This is described in further detail in FIG. 5.

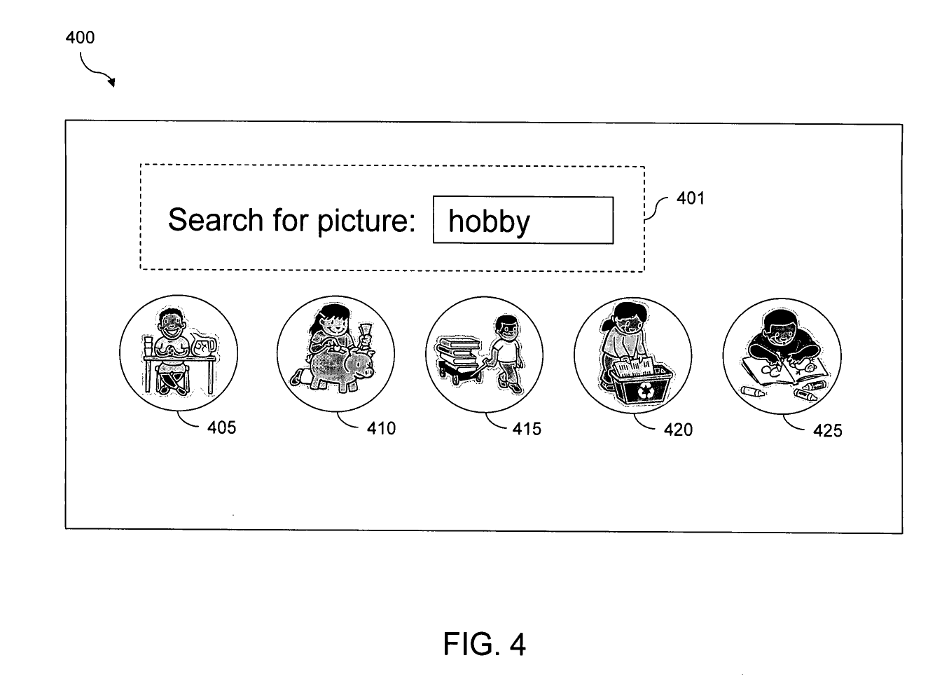

FIG. 4 illustrates one embodiment of the pictorial search window described in step 215. As part of the pictorial message creation process, the user must assemble a collection of pictures. Locating these pictures in the pictorial database requires a tool that allows the user to search for pictures based on their preferred language. The tool 400 shows one embodiment of this process.

The user begins by entering a word in their preferred language 401. After the word is entered, the search can be instigated in a variety of manners. The search may begin after the user presses “Enter”, after clicking on a button to begin the search, or automatically after every letter is entered into the system. An alternate way of doing this may be via voice-recognition software. In the example in the picture, the user has entered the word “hobby”, as they are looking for a representative picture.

The search results are returned in cells 405, 410, 415, 420, and 425. These results all have the word “hobby” associated with them in the definitions database. The order in which they are returned can either be random or based on a number of preferential criteria. In the case of this example, they are returned by picture-usage popularity. This indicates that the result in 405 is more often chosen by users as the correct picture for “hobby” than the picture in 410. The picture in 410 is more popular than the one in 415, and so on. After the user chooses one of these pictures, the picture is then inserted into the Cartesian plane represented in FIG. 3.

The flowchart in FIG. 5 illustrates how a common pictorial message can be read by users who speak different languages. In step 500, the user first selects to view a message. The pictorial message is then displayed to the user in step 510. In the next step 520, the user chooses to see the word translation for the pictorial message which is currently being viewed. However, it may be the case that the pictorial message so clearly indicates the meaning of the message that no translation or definition is necessary. If the user does want to see a definition of one or more of the pictures in the pictorial message, the user may do so in the user's preferred language. Each user has personal preferences, with language preferences being a pertinent category for this exercise. The language preferences work with the definitions database. The definitions database is tied to the picture database, where every picture has a definition. These two databases (which may physically exist inside one database and be linked tables) embed their data into the message. These definitions may be seen in a variety of manners including mouseover events, computer-translated spoken language, or a separate window that creates natural sentence translations.

The user can have any preferred language, but in this example, it is assumed that a user either has English or Japanese as a preferred language. In step 530, the system determines the preferred language for the user, which is typically predefined by the user in advance. If the user's preferred language is Japanese, the system will query the data storage to retrieve the Japanese word translation for the pictorial message in step 540. The system can offer a picture by picture translation, or attempt to provide a more precise word translation by examining the connectors and the combination of pictures included in the pictorial message. In step 550, the Japanese word translation is displayed to the user.

If the user's preference is English instead of Japanese in step 530, the system queries the data storage to discover the English translation, in step 560. Similarly, the English translation is displayed to the user in step 570 once discovered.

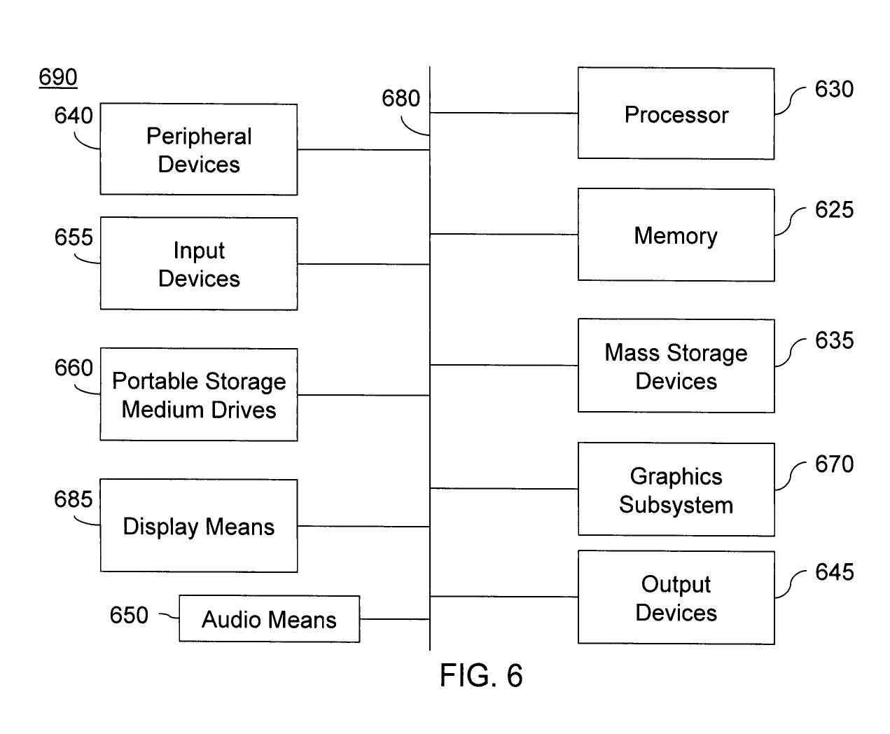

FIG. 6 illustrates a high-level block diagram of a general purpose computer which is used, in one embodiment, to implement the method and system of the present invention. The general purpose computer of FIG. 6 includes a processor 630 and memory 625. Processor 630 may contain a single microprocessor, or may contain a plurality of microprocessors, for configuring the computer system as a multi-processor system. In alternative embodiments described above, the processor 630 includes the server processor and client processor of FIGS. 1, 3 and 4 above. Memory 625, stores, in part, instructions and data for execution by processor 630. If the system of the present invention is wholly or partially implemented in software, including computer instructions, memory 625 stores the executable code when in operation. Memory 625 may include banks of dynamic random access memory as well as high speed cache memory.

The computer of FIG. 6 further includes a mass storage device 635, peripheral device(s) 640, audio means 650, input device(s) 655, portable storage medium drive(s) 660, a graphics subsystem 670 and a display means 785. For purposes of simplicity, the components shown in FIG. 1 are depicted as being connected via a network (i.e. transmitting means). However, the components may be connected through a bus 680 on a single general purpose computer. For example, processor 630 and memory 625 may be connected via a local microprocessor bus, and the mass storage device 635, peripheral device(s) 640, portable storage medium drive(s) 660, and graphics subsystem 670 may be connected via one or more input/output (I/O) buses. Mass storage device 635, which is typically implemented with a magnetic disk drive or an optical disk drive, is in one embodiment, a non-volatile storage device for storing data and instructions for use by processor 630. The mass storage device 635 includes the storage medium of embodiments of the present invention, and the server storage medium and client storage medium in alternative embodiments. In another embodiment, mass storage device 635 stores the first and second algorithms of the server in an embodiment of the present invention. The computer instructions that implement the method of the present invention also may be stored in processor 630.

Portable storage medium drive 660 operates in conjunction with a portable non-volatile storage medium, such as a flash memory, wireless storage device, floppy disk, or other computer-readable medium, to input and output data and code to and from the computer system of FIG. 6. In one embodiment, the method of the present invention that is implemented using computer instructions is stored on such a portable medium, and is input to the computer system 690 via the portable storage medium drive 660. Peripheral device(s) 640 may include any type of computer support device, such as an input/output (I/O) interface, to add additional functionality to the computer system 690. For example, peripheral device(s) 640 may include a network interface card for interfacing computer system 690 to a network, a modem, and the like.

Input device(s) 655 provide a portion of a user interface. Input device(s) 655 may include an alpha-numeric keypad for inputting alpha-numeric and other key information, or a pointing device, such as a mouse, a trackball, stylus or cursor direction keys. Such devices provide additional means for interfacing with the customized media list and the customized media in the method of the present invention. In order to display textual and graphical information, the computer of FIG. 6 includes graphics subsystem 670 and display means 685. Display means 685 may include a cathode ray tube (CRT) display, liquid crystal display (LCD), other suitable display devices, or means for displaying, that enables a user to view the customized media list or customized media. Graphics subsystem 670 receives textual and graphical information and processes the information for output to display 685. The display means 685 provides a practical application for providing the customized media list of the present invention since the method of the present invention may be directly and practically implemented through the use of the display means 685. The computer system of FIG. 6 also includes an audio system 650. In one embodiment, audio means 650 includes a sound card that receives audio signals from a microphone that may be found in peripherals 640. In another embodiment, the audio system 650 may be a processor, such as processor 630, that processes sound. Additionally, the computer of FIG. 6 includes output devices 645. Examples of suitable output devices include speakers, printers, and the like.

The devices contained in the computer system of FIG. 6 are those typically found in general purpose computer, and are intended to represent a broad category of such computer components that are well known in the art. The system of FIG. 6 illustrates one platform which can be used for practically implementing the method of the present invention. Numerous other platforms can also suffice, such as Macintosh-based platforms available from Apple Computer, Inc., video game platforms such as handheld devices from Nintendo (like the Nintendo DS) and from Sony (like the Sony PSP), platforms based on mobile phones that feature graphical user interfaces, platforms with different bus configurations, networked platforms, multi-processor platforms, other personal computers, workstations, mainframes, navigation systems, and the like.

Furthermore, disparate devices may be used to facilitate communication. Varieties of devices may work in conjunction to create and deliver messages to users. For example, cell phones can deliver pictorial messages to console users, a console controller can deliver information to a PC via a console that is attached to a data network, or a handheld gaming device can be used to deliver messages to a cell phone.

In a further embodiment, the present invention also includes a computer program product which is a computer readable medium (media) having computer instructions stored thereon/in which can be used to program a computer to perform the method of the present invention. The storage medium can include, but is not limited to, any type of disk including flash memory, hard disks, floppy disks, optical disks, DVD, Writable DVDs, CD ROMs, magnetic optical disks, RAMs, EPROM, EEPROM, magnetic or optical cards, or any type of media suitable for storing electronic instructions.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A method of creating a pictorial message by a user, said method comprising the steps of:
searching for a preferred picture to add to said pictorial message by said user;
selecting said preferred picture from the search results if said user finds one suitable;
adding a new said preferred picture to the system if said user does not find anything suitable from said search results;
placing said preferred picture on a grid in a location determined by said user; and
affixing connections between said preferred picture and another picture on said grid.

2. The method of claim 1, wherein said search results are sorted by popularity.

3. The method of claim 1, wherein said search results are sorted by relevance.

4. The method of claim 1, wherein said preferred picture is an animated image.

5. The method of claim 1, wherein said preferred picture contains audio.

6. The method of claim 1, wherein said grid is a Cartesian plan comprised of cells into which pictures may be placed in an order as desired by said user.

7. The method of claim 1, wherein said grid is three dimensional.

8. The method of claim 1, wherein said grid contains pictures oriented in a consecutive linear order.

9. The method of claim 1, wherein said connection is a graphical symbol used to communicate the relationship between said preferred picture and said another picture.

10. The method of claim 9, wherein said connection is used to overlay existing pictures to create new meanings and relationships.

11. The method of claim 1, wherein said step of searching comprises the substeps of:
inputting a search term by said user in the said user's preferred language;
retrieving matching pictures that relate to said search term; and
presenting said matching pictures to said users.

12. The method of claim 11, wherein said step of inputting is performed through voice recognition.

13. A method of communicating with a pictorial message, said method comprising the steps of:
creating said pictorial message by a sender;
specifying, by said sender, the destination of said pictorial message to be received by a receiver;
delivering said pictorial message to said destination; and
viewing by said receiver the translation of said pictorial message in said receiver's preferred language.

14. The method of claim 13, wherein said step of creating is performed on a computer.

15. The method of claim 13, wherein said step of creating is performed on a handheld gaming system.

16. The method of claim 13, wherein said step of creating is performed on a console system attached to a cellular phone.

17. The method of claim 13, wherein said step of viewing is performed on a computer.

18. The method of claim 13, wherein said step of viewing is performed on a handheld gaming system.

19. The method of claim 13, wherein said step of viewing is performed on a console system attached to a cellular phone.

20. The method of claim 13, wherein said destination is a group list.

21. The method of claim 13, wherein said step of delivering is via email.

22. The method of claim 13, wherein said step of delivery is via instant messenger.

23. The method of claim 13, wherein said pictorial message is comprised of pictures and connections on a grid.

24. The method of claim 13, wherein said step of viewing comprises the substeps of:
presenting said pictorial message to said receiver;
defining the translation of said pictorial message in said receiver's preferred language; and
viewing said translation by said receiver.

25. The method of claim 24, wherein said step of presenting is through a tooltip.

26. The method of claim 24, wherein said step of defining is performed by said receiver via a toggle button which changes said pictorial message to said translation.

27. A method for a pictorial message to be displayed by an avatar for the purpose of communication with the user comprising the steps of:
creating said pictorial message by the computer, where the pictures are chosen according to a set of information that needs to be communicated to the user;
positioning of said avatar on said user's screen; and
displaying said pictorial message on said screen.

28. The method of claim 27, wherein said step of positioning said avatar further comprises the step of positioning said avatar such that said avatar appears to be communicating with another avatar.

29. The method of claim 27, wherein said step of positioning said avatar further comprises the step of positioning said avatar such that said avatar appears to be communicating with an inanimate object.
